(19) United States
(12) Patent Application Publication
(10) Pub. No.: US 2002/0163964 A1
(43) Pub. Date: Nov. 7, 2002

(54) Apparatus and method for compressing video

(76) Inventor: James B. Nichols, Los Altos, CA (US)

Correspondence Address: Thomas C. Webster, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/848,118

(22) Filed: May 2, 2001

(51) Int. Cl. H04N 7/12

(52) U.S. Cl. 375/240.03; 375/240.24; 375/240.2

(57) ABSTRACT

A computer-implemented method is described for compressing video, the method comprising: calculating an activity metric for a macroblock in a first field; and selecting a quantizer scaling value for a corresponding macroblock in a second field based on the calculated activity metric.

Also described is an apparatus for compressing data comprising: an activity metric analysis module to calculate an activity metric for macroblocks in a first field; and a scaling variable selector module to select a quantizer scaling value for corresponding macroblocks in a second field based on the calculated activity metric.

### BACKGROUND

1. Field of the Invention

This invention relates generally to the field of data compression. More particularly, the invention relates to a improved video codec for compressing and decompressing video content.

2. Description of the Related Art

A prior art system for receiving and storing an analog multimedia signal is illustrated in FIG. 1a. As illustrated a selector 107 is used to choose between either a baseband video input signal 102 or a modulated input signal 101 (converted to baseband via a tuner module 105). A digitizer/decoder module 110 performs any necessary decoding of the analog signal and converts the analog signal to a digital signal (e.g., in a standard digital format such as CCIR-601 or CCIR-656 established by the International Radio Consultative Committee).

An MPEG-2 compression module 115 compresses the raw digital signal in order to conserve bandwidth and/or storage space on the mass storage device 120 (on which the digital data will be stored). Using the MPEG-2 compression algorithm, the MPEG-2 compression module 115 is capable of compressing the raw digital signal by a factor of between 20:1 and 50:1 with an acceptable loss in video image quality. However, in order to compress a standard television signal (e.g., NTSC, PAL, SECAM) in real-time, the MPEG-2 compression module 115 requires approximately 8 Mbytes of RAM 116 (typically Synchronous Dynamic RAM or “SDRAM”). Similarly, after the video data has been compressed and stored on the mass storage device 120, the prior art system uses an MPEG-2 decompression module 130 and approximately another 8 Mbytes of memory 116 to decompress the video signal before it can be rendered by a television 135.

Prior art systems may also utilize a main memory 126 for storing instructions and data and a central processing unit (“CPU”) 125 for executing the instructions and data. For example, CPU may provide a graphical user interface displayed on the television, allowing the user to select certain television or audio programs for playback and/or storage on the mass storage device 120.

A prior art system for receiving and storing digital multimedia content is illustrated in FIG. 1b. Although illustrated separately from the analog signal of FIG. 1a, it should be noted that certain prior art systems employ components from both the analog system of FIG. 1a and the digital system from FIG. 1b (e.g., digital cable boxes which must support legacy analog cable signals).

As illustrated, the incoming digital signal 103 is initially processed by a quadrature amplitude modulation (“QAM”) demodulation module 150 followed by a conditional access (“CA”) module 160 (both of which are well known in the art) to extract the underlying digital content. As indicated in FIG. 1b, the digital content is typically an MPEG-2 multimedia stream with a compression ratio selected by the cable TV or satellite company broadcasting the signal. The MPEG-2 data is stored on the mass storage device 120 from which it is read and decompressed by an MPEG-2 decompression module 130 (typically using another 8 Mbytes of RAM) before being transmitted to the television display 135.

One problem associated with the foregoing systems is that the memory and compression logic required to compress and decompress multimedia content in real time represents a significant cost to manufacturers. For example, if 8 Mbytes of SDRAM costs approximately $8.00 and each of the compression and decompression modules cost approximately $20.00 (currently fair estimates), then the system illustrated in FIG. 1a would require $56.00 to perform the compression/decompression functions for a single multimedia stream. Moreover, considering the fact that many of these systems include support for multiple multimedia streams (e.g., two analog streams and two digital streams), the per-unit cost required to perform these functions becomes quite significant.

Another problem with the digital system illustrated in FIG. 1b is that it does not allow users to select a particular compression level for storing multimedia content on the mass storage device 120. As mentioned above, the compression ratio for the MPEG-2 data stream 170 illustrated in FIG. 1b is selected by the digital content broadcaster (e.g., digital cable, satellite, Webcaster, . . . etc). In many cases, however, users would be satisfied with a slightly lower level of video quality if it would result in a significantly higher MPEG-2 compression ratio (and therefore more available storage space on the mass storage device).

Accordingly, what is needed is a more efficient mechanism for compressing and decompressing multimedia content on a multimedia storage and playback device. What is also needed is an apparatus and method which will allow users to select a compression ratio and/or compression type suitable to their needs (e.g., based on a minimum level of quality given the capabilities of their mass storage devices). What is also needed is an apparatus and method for compressing/decompressing video in real time using less memory and processing power than current systems while maintaining a comparable level of video quality.

### SUMMARY OF THE INVENTION

A computer-implemented method is described for compressing video, the method comprising: calculating an activity metric for a macroblock in a first field; and selecting a quantizer scaling value for a corresponding macroblock in a second field based on the calculated activity metric.

Also described is an apparatus for compressing data comprising: an activity metric analysis module to calculate an activity metric for macroblocks in a first field; and a scaling variable selector module to select a quantizer scaling value for corresponding macroblocks in a second field based on the calculated activity metric.

### BRIEF DESCRIPTION OF THE DRAWINGS

A better understanding of the present invention can be obtained from the following detailed description in conjunction with the following drawings, in which:

FIGS. 1a and 1b illustrate prior art multimedia storage and playback systems.

FIG.2 illustrates one embodiment of a system for intelligent multimedia compression and distribution.

FIG. 3 illustrates coordination between compressed and uncompressed multimedia data according to one embodiment of the invention.

FIG. 4 illustrates one embodiment of the invention employing a light compression algorithm.

FIG. 5 illustrates one embodiment of the invention for performing data compression conversion on a digital multimedia signal.

FIG. 6 illustrates compressed and uncompressed buffer coordination according to one embodiment of the invention.

FIG. 7a-c illustrate embodiments of the invention which employ compression algorithms adapted to be executed in real time using a general purpose processor.

FIG. 8 illustrates frames, fields, macroblock lines and macroblocks within an MPEG-2 video stream.

FIG. 9 illustrates a prior art system for performing a discrete cosine transform (“DCT”).

FIG. 10 illustrates the relationship between bitrate and quantizer scale.

FIG. 11 illustrates a video frame containing a complex region and a non-complex region.

FIG. 12 illustrates a computer-implemented method according to one embodiment of the invention.

FIG. 13 illustrates an apparatus for compressing video data according to one embodiment of the invention.

FIG. 14 illustrates the amount of bits encoded within each macroblock of a particular video image.

FIG. 15 illustrates bit allocation hierarchy according to one embodiment of the invention.

### DETAILED DESCRIPTION

In the following description, for the purposes of explanation, numerous specific details are set forth in order to provide a thorough understanding of the present invention. It will be apparent, however, to one skilled in the art that the invention may be practiced without some of these specific details. In other instances, well-known structures and devices are shown in block diagram form to avoid obscuring the underlying principles of the invention.

### Embodiments of an Apparatus and Method for Intelligent Multimedia Compression and Distribution

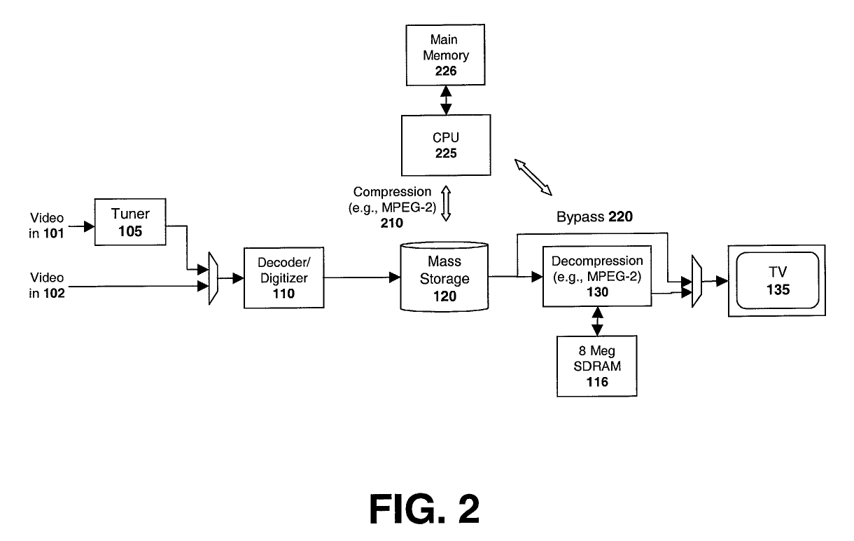

As shown in FIG. 2, one embodiment of the invention is comprised of one or more tuners 105 for converting an incoming analog signal to a baseband analog signal and transmitting the baseband signal to a decoder/digitizer module 110. The decoder/digitizer module 110 decodes the signal (if required) and converts the signal to a digital format (e.g., CCIR-601 or CCIR-656 established by the International Radio Consultative Committee).

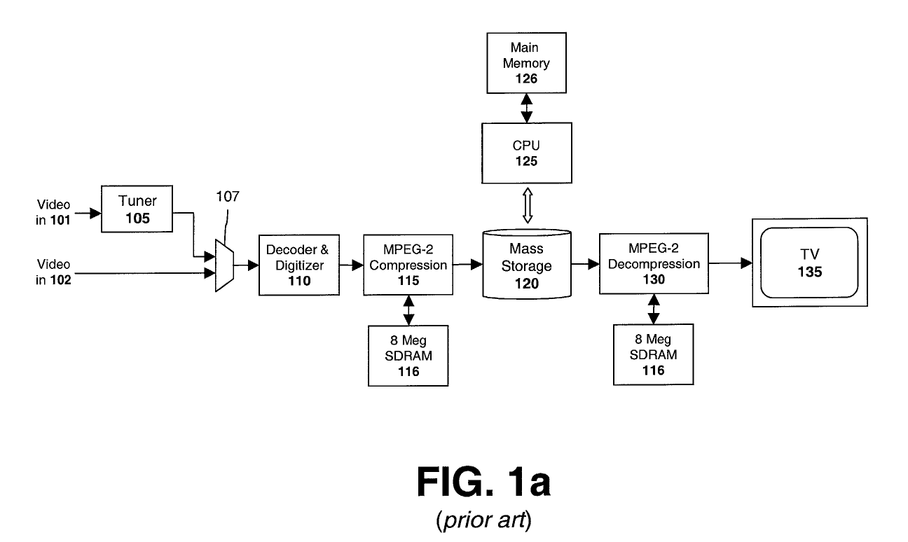

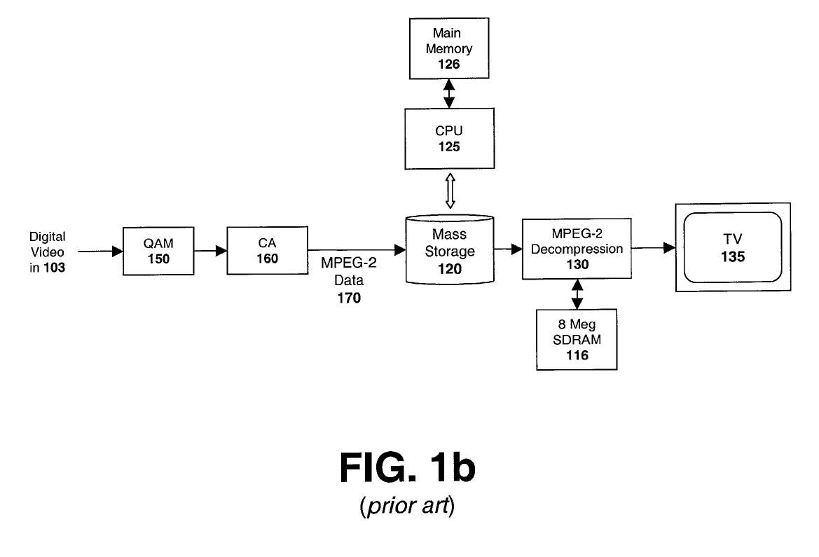

Unlike prior art systems, however, the system illustrated in FIG. 2 transfers the digital content directly to the mass storage device 120 without passing it through an MPEG-2 (or any other) compression module (e.g., such as module 115 in FIG. 1a). Accordingly, the mass storage device 120 has enough capacity to handle the incoming uncompressed digital video stream (uncompressed content will take up significantly more space on the mass storage device 120). In addition, the mass storage device 120 of one embodiment is capable of supporting the bandwidth required by the uncompressed digital video signal. For example, a typical MPEG-2 compressed video signal requires a bandwidth of between 2 Mbits/sec and 5 Mbits/sec, whereas the same signal may require approximately 120 Mbits/sec in an uncompressed format. Therefore, the mass storage device 120 in one embodiment is coupled to the system via an Ultra DMA-66/Ultra ATA-66 or faster interface (capable of supporting a throughput of up to 528 Mbits/sec), and has a storage capacity of 80 Gbytes or greater (a relatively inexpensive mass storage device by today's standards). It should be noted, however, that the particular interface type/speed and drive storage capacity is not pertinent to the underlying principles of the invention. For example, various different interfaces such as Small Computer System Interface (“SCSI”) may be used instead of the Ultra-ATA/Ultra DMA interface mentioned above, and various different drive capacities may be employed for storing the incoming digital content.

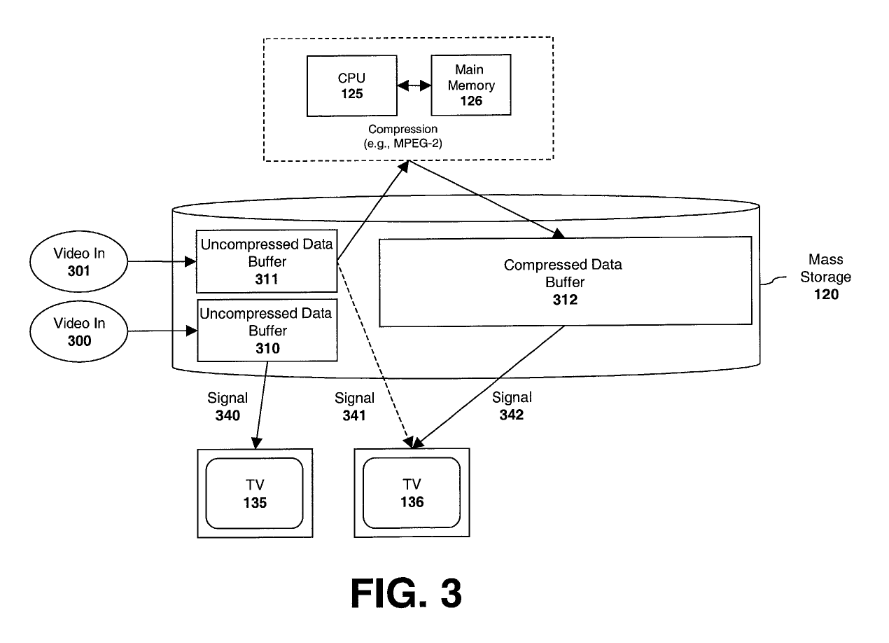

Although the digital content is initially stored in an uncompressed format, in one embodiment of the invention, the CPU 225 works in the background to compress the content by executing a particular compression algorithm (e.g., MPEG-2). Accordingly, referring now to FIG. 3, if a user chooses to record a particular television program represented by video input 301 (or other multimedia content), it will initially be stored in an uncompressed data buffer 311 on the mass storage device. However, using the MPEG-2 compression algorithm (or other algorithm as described below), the CPU will work in the background to compress the content and transfer the compressed content to a compressed data buffer 312. Even though the CPU may not have sufficient processing power to compress the incoming data stream in real time (although in some cases it may as described below), it is still capable of compressing the data given a sufficient amount of time to do so (e.g., as a background task). Thus, even a general purpose processor such as an Intel Pentium III®, AMD Althon®, or QED MIPS R5230 processor may be used to compress the multimedia data.

In addition, only a relatively small amount of standard memory 126 is required to perform the compression algorithm due to the fact that, in one embodiment, the system may establish large swap files for working with the multimedia data during the compression and/or decompression procedures (see below). In one embodiment, the swap file configuration may be set by the end user and controlled by an operating system executed on the CPU. For that matter, many of the operations described herein may be scheduled and executed with the aid of a multithreaded, multitasking operating system such as Linux, UNIX, Windows NT®, with realtime and non-realtime multimedia streaming and compression functions built in.

If all of the multimedia content for the multimedia program has been compressed and stored in the compressed data buffer 312 at the time the user attempts to watch the program, then it will be decompressed by the MPEG-2 decompression module 130 before being rendered on the user's television display 136 (represented by signal 342 in FIG. 3). If, however, the program has not been fully compressed (e.g., a percentage of the data is still stored in the uncompressed data buffer), then the portion of the data which is compressed will initially be transmitted to the user through the MPEG-2 decompression module 130 until all the compressed data has been consumed (i.e., until the compressed data buffer is empty). Once the compressed data is consumed, the remaining portion of the program residing in the uncompressed data buffer will be transmitted directly to the television 136 (represented by bypass signal 220). In other words, because the data is uncompressed it does not need to be processed by the MPEG-2 compression module 130.

In one embodiment, a control program executed by the CPU coordinates the data transmissions between the various compressed/uncompressed data buffers 311, 312 and data transmissions from the data buffers 311, 312 to the end user as described above (e.g., the control program may determine when to switch from the compressed data buffer to the uncompressed data buffer).

When a user chooses to watch a live television program or other live multimedia event such as a Webcast (represented by video input 300), one embodiment of the system transmits the incoming multimedia data to an uncompressed data buffer 310 and from the uncompressed data buffer 310 directly to the television 135 or other multimedia rendering device (i.e., signal 340 in FIG. 3). Accordingly, in this embodiment, for live broadcast events no multimedia compression or decompression is required. In addition, the uncompressed data buffer 310 may be configured to store a user-specified amount of data from the live broadcast, thereby providing support for real-time “trick modes” such as pause or rewind for live television. The amount of data stored in the uncompressed data buffer 310 for these purposes may be based on the capacity of the mass storage device employed on the system. For example, a typical uncompressed digital video signal will consume approximately 50 Gbytes/hour. As such, if the system illustrated in FIGS. 2 and 3 employs a 100 Gbyte mass storage device 120, one-quarter of the capacity of the device may be allocated to store ½ hour of live multimedia content with the remaining portion allocated for long term storage (e.g., employing the CPU-based compression techniques described above). In one embodiment, the size of the long-term buffer(s) and the live broadcast buffer(s) is configurable by the user. For example, users who have no interest in “trick modes” may allocate all of the mass storage device 120 capacity to long term storage.

In sum, the system described above with respect to FIGS. 2 and 3 provides the same features of prior systems (e.g., trick modes and long term storage of multimedia content) but at a significantly lower cost than prior systems due to the fact that it is capable of performing multimedia compression using a general purpose processor in non-real-time and a high-capacity, high speed mass storage device.

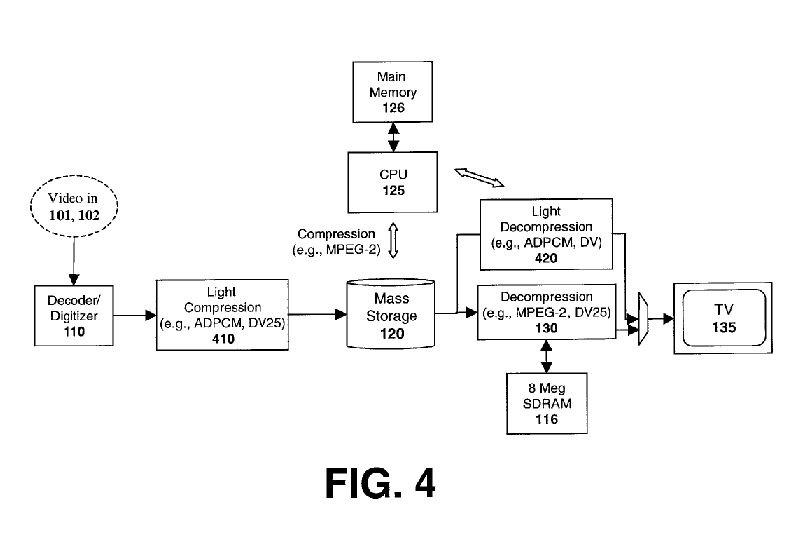

A related embodiment of the invention illustrated in FIG. 4 includes a light compression module 410 for compressing the incoming digital signal in real time before the content is stored on the mass storage device 120. The primary difference between the light compression module 410 and the MPEG-2 compression module 115 (FIG. 1a), however, is that the light compression module 410 requires less memory and processing logic (i.e., silicon gates) to execute its compression algorithm (and is therefore less costly to manufacture). For example, an adaptive differential pulse code modulation (“ADPCM”) algorithm may be employed with as little as 1280 bytes of memory (because ADPCM evaluates entropy between adjacent video pixels rather than several adjacent video frames as does MPEG-2). Although ADPCM is not capable of the same level of compression as MPEG-2, it is still capable of compressing a standard NTSC video signal in real time at a ratio of between 3:1 and 4:1. As such, for a nominal additional expense, the ADPCM compression module 410 and corresponding decompression module 420 will increase the effective capacity of the “uncompressed” data buffers 310, 311 illustrated in FIG. 3 by a multiple of between 3× and 4×. In all other respects, the embodiment illustrated in FIG. 4 may be configured to function in the same manner as the embodiments illustrated in FIGS. 2 and 3. For example, the digital content stored in an ADPCM-compressed format in buffer 311 may be compressed in the background by the CPU 125 using a more intensive compression algorithm such as MPEG-2 and stored in buffer 312. Similarly, for live broadcasts the ADPCM-compressed data may be transmitted from data buffer 310 to the light decompression module 420 for decompression, and then to the user's television 135 (or other multimedia rendering device).

In one particular embodiment, the light compression modules configured in the system provide intra-frame coding/decoding (i.e., compression/coding within each individual video frame) whereas the standard compression and/or decompression modules (e.g., MPEG-2 decompression module 130) provide both inter- and intra-frame coding, using coding techniques between successive frames as well as within each frame (e.g., such as motion compensation and frame differencing for MPEG-2). For example, in one embodiment, the light compression module 410 is configured with the Digital Video (“DV25”) compression algorithm for intra-frame coding (see, e.g., the IEC 61834 digital video standard). DV25 compression uses a discrete cosine transform (“DCT”) which provides a compression ratio of approximately 5:1. One additional benefit of using DV25 compression in this context is that, because the MPEG-2 module 130 includes DCT logic, the DCT portion of the MPEG-2 decompression module 130 may be used to decompress the DV25-compressed video stream. Accordingly, if DV25 compression is used, a separate light decompression module 420 may not be necessary, thereby further reducing system cost. In addition, the CPU may work in the background to compress the multimedia content using MPEG-2 (which utilizes both inter-frame and intra-frame coding techniques) to achieve a higher compression ratio for long term storage.

It should be noted that various light compression algorithms other than ADPCM and DV25 may be implemented while still complying with the underlying principles of the invention. In fact, the light compression module 410 may use virtually any compression algorithm which requires less memory and/or fewer silicon gates to implement than the “standard” video compression algorithm used in the system (e.g., such as MPEG-2).

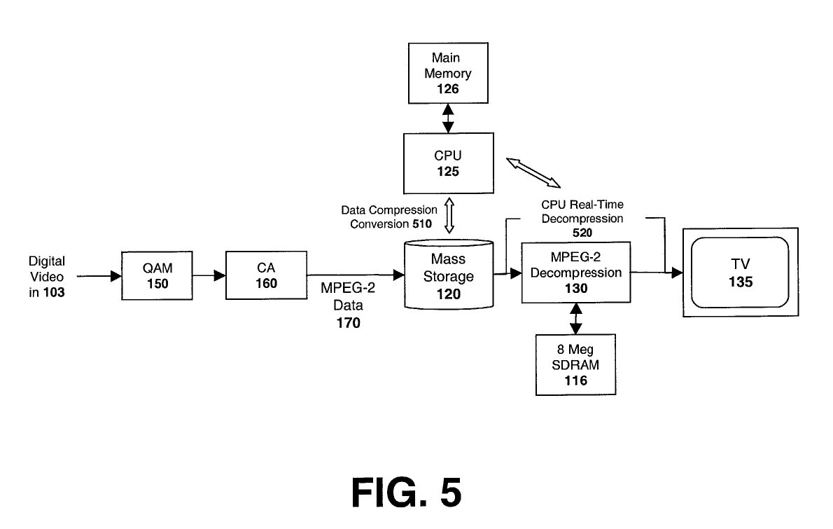

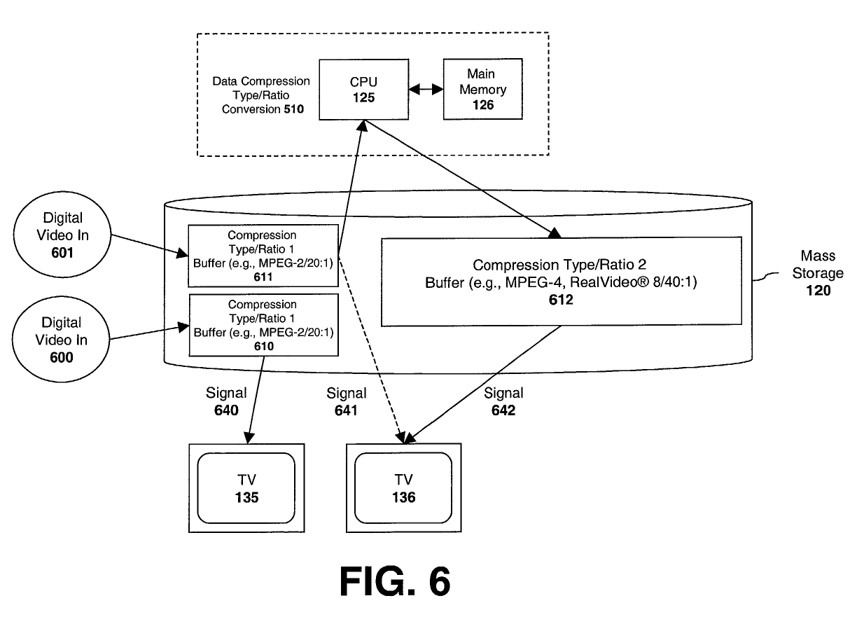

FIG. 5 illustrates one embodiment of the invention for compressing and storing a digital multimedia signal 103. The particular embodiment illustrated in FIG. 5 includes a QAM module 150 and a conditional access module 160 for extracting the underlying MPEG-2 data stream 170. The MPEG-2 multimedia stream (or other compressed data stream) is initially stored on the mass storage device 120 as in prior systems. Unlike prior systems, however, the system illustrated in FIG. 5 allows users to specify a data compression ratio other than the compression ratio and/or compression type with which the multimedia content is broadcast. For example, referring also to FIG. 6, in one embodiment, the MPEG-2 stream is initially transmitted to buffer 611 on the mass storage device 120 at the same compression ratio as which it was transmitted—20:1. Certain users, however, may be satisfied with a higher compression level (and corresponding decrease in quality) for everyday television viewing. As such, the illustrated embodiment allows the user to select a higher compression ratio such as 40:1 for specified programs (e.g., programs recorded from a satellite broadcast). As indicated in FIG. 5, the CPU will then work in the background to convert the 20:1 MPEG-2 video to the 40:1 compression ratio. For MPEG-2-compressed data this means that the CPU will decompress the 20:1 MPEG-2 data to raw data (e.g., CCIR-601) and then recompress the raw data using the 40:1 compression algorithm. For other types of multimedia compression, the system may not need to fully decompress and then recompress the entire signal (i.e., the system may simply convert the signal using a conversion algorithm). Once the conversion process is complete, the multimedia content stored in buffer 612 will take up ½ the space on the mass storage device 120.

When the user selects the recorded program for viewing, it will be streamed to his television from buffer 612, through the MPEG-2 decompression module 130. If, as described above, the entire background process is not complete when the viewer selects the recorded program (i.e., if only a portion of the 20:1 data has been converted to 40:1 data), then the portion of the data which is compressed and 40:1 and stored in buffer 612 will initially be transmitted to the television (or other display device) until all of the 40:1 compressed data has been consumed (i.e., until the compressed data buffer 612 is empty). Once the 40:1 compressed data is fully consumed, the remaining portion of the data residing in the 20:1 compressed data buffer 611 will be transmitted to the television 136 (represented by signal 641).

Moreover, for live broadcasts (e.g., cable, satellite, Webcast) a user-specified amount of the MPEG-2 data will be stored directly in buffer 610 and streamed to the television 135 through the MPEG-2 decompression module 130 (represented by signal 640), thereby providing support for real-time “trick modes” such as pause or rewind for live television. As described above, the amount of data stored in the 20:1 compressed data buffer 610 for these purposes may be based on the capacity of the mass storage device employed on the system.

Moreover, in one embodiment, users may select a compression type for recorded multimedia programs (i.e., other than the compression type with which the digital signal was broadcast). For example, new compression algorithms such as MPEG-4 and Real Video 8 will achieve a significantly higher compression ratio at the same quality level as MPEG-2. As such, by selecting one of these new compression types, users can free up space on the mass storage device 120 while maintaining the same level of video image quality. Moreover, certain compression types (e.g., Real Video 8) are designed to perform video compression in real time on a general purpose CPU. As indicated in FIG. 5, if one of these CPU-based compression algorithms are selected, the digital content will be read from the storage buffer 612 and decompressed in real-time by the CPU rather than the MPEG-2 decompression module 130.

In other respects, the system works in a similar manner as described above with respect to compression ratio conversion. When the user selects the recorded program for viewing, it will be streamed to his television from buffer 612, and decompressed by the CPU. If, as described above, the entire background process is not complete when the viewer selects the recorded program (i.e., if only a portion of the data has been converted to the new compression type), then the portion of the data in buffer 612 will initially be transmitted to the television (or other display device) until all of the newly-compressed data has been consumed. Then, the remaining portion of the data residing in the standard compression buffer 611 will be transmitted to the television 136 as represented by signal 641. Similarly, for live broadcasts (e.g., cable, satellite, Webcast) a user-specified amount of the MPEG-2 data will be stored directly in buffer 610 and streamed to the television 135 through the MPEG-2 decompression module 130 (represented by signal 640), thereby providing support for real-time “trick modes” such as pause or rewind for live television.

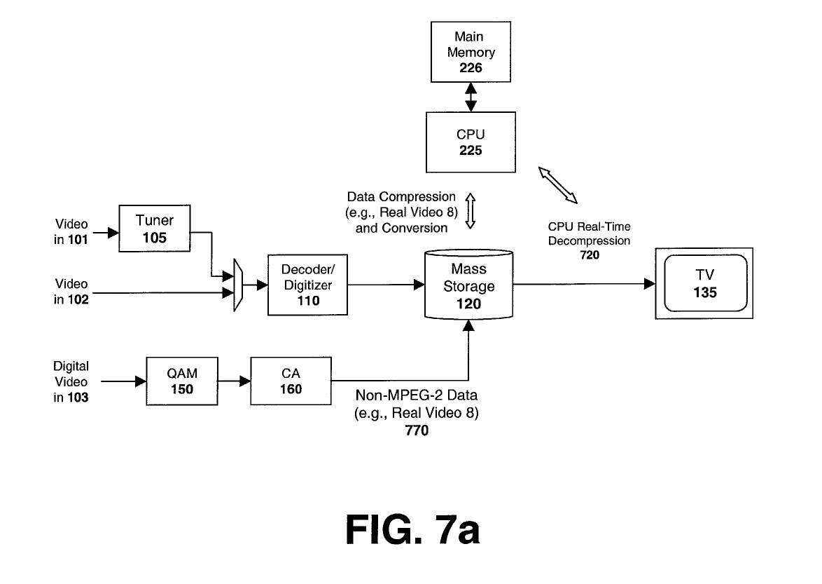

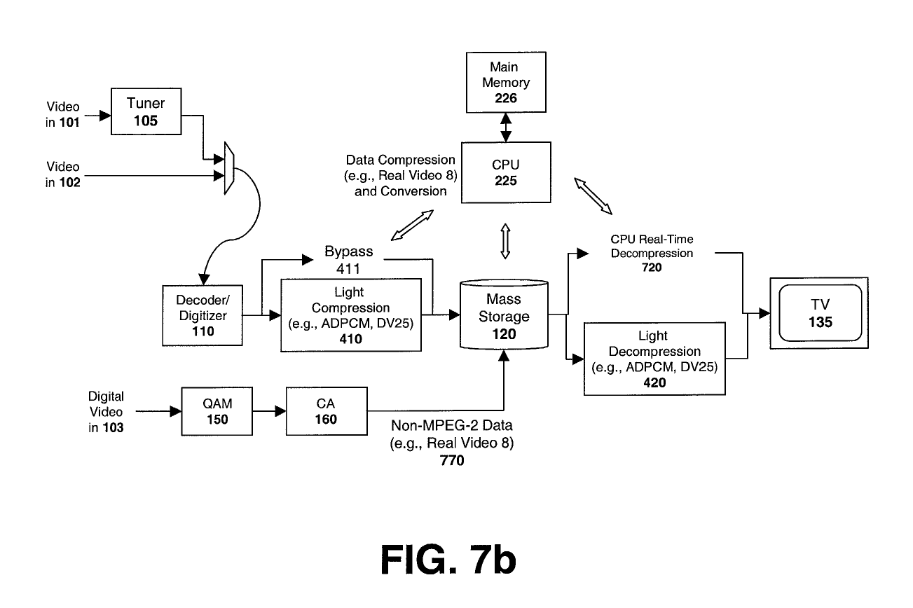

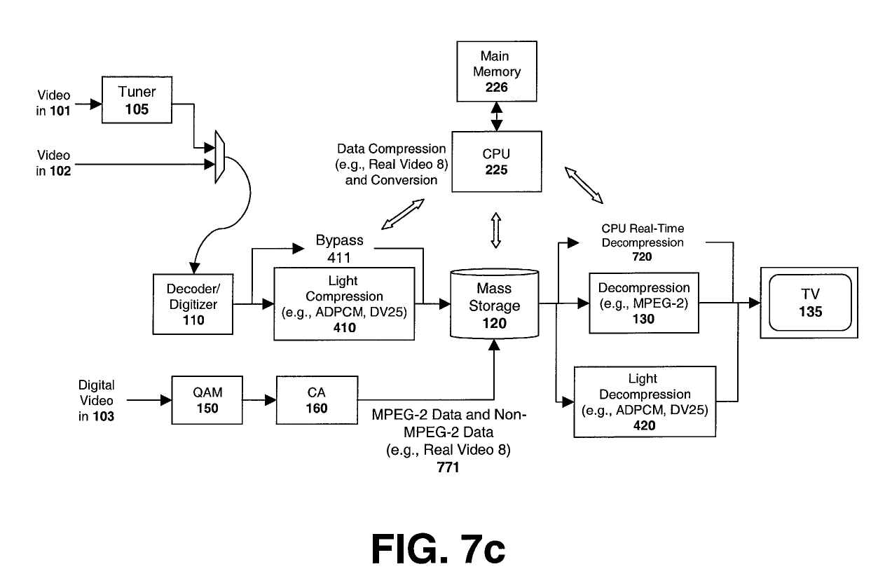

As described above, certain compression algorithms such as Real Video 8 may be executed in real time on a general purpose CPU. Accordingly, FIG. 7a illustrates one embodiment of the invention in which analog video signals 101, 102, after being digitized/decoded, are immediately compressed by the CPU using one of these compression algorithms and stored on the mass storage device 120. Similarly, digital signals 103 may be transmitted by cable and satellite operators using the improved compression algorithm and stored directly on the mass storage device 120, thereby conserving communication bandwidth and storage device 120 space due to the improved data compression ratios. Moreover, as illustrated, no dedicated compression modules and associated memory are required to perform compression and decompression, thereby significantly decreasing manufacturing costs.

As with prior embodiments, users may choose higher or lower compression ratios for recorded multimedia content to conserve space on the mass storage device 120. The user-selected compression ratios may be implemented immediately on the analog signals 101, 102. With respect to the digital signals 103, if the compression ratio selected by the user is different from the compression ratio with which the data is broadcast, then one embodiment of the system will operate as described above, converting the data to the new compression ratio by decompressing and then recompressing the data.

In one embodiment illustrated in FIG. 7b, a light compression module 410 may also be configured in the system to compress the multimedia content in real time before it is stored on the mass storage device 120. The CPU may then work in the background to compress the data using a different algorithm (e.g., Real Video 8). This embodiment is may be employed to free up processing power for other tasks such as compressing/decompressing other multimedia content (e.g., the digital video input 103) using a more processor-intensive compression algorithm. In one embodiment, the light compression module 410 may be used to compress data to support “trick” modes for live broadcasts (e.g., wherein a predetermined amount of live data is stored to support functions such as “pause” and “rewind”), whereas the standard compression and decompression implemented by the CPU may be used for long term multimedia storage.

In one embodiment, illustrated in FIG. 7c, both MPEG-2 data and/or non-MPEG-2 data (i.e., signal 771) may be transmitted by the multimedia content provider. Accordingly, this embodiment may include an MPEG-2 decompression module 130 for decompressing the MPEG-2 data in addition to the CPU real-time decompression 720 and/or light decompression module 420. As such, this embodiment may be employed by a variety of different content providers (e.g., digital cable, satellite, Webcast, digital broadcast, . . . etc) regardless of the format in which the content provider transmits the underlying multimedia content. Once again, in one embodiment, the light compression module 410 may be used to compress data for “trick” modes for live broadcasts, whereas the standard compression and decompression (both MPEG-2 and non-MPEG-2) may be used for long term multimedia storage.

In one embodiment, the multimedia content stored in the “trick mode” uncompressed data buffers described herein (e.g., buffer 310) may also be compressed in the background by the CPU and stored in a compressed trick mode buffer (not shown). Similarly, multimedia content may be stored in a first trick mode buffer at a first compression ratio/type (e.g., at which it was transmitted by the multimedia content broadcaster), converted as a background task by the CPU to a second compression ratio/type and stored in a second trick mode buffer. Accordingly, the same techniques described herein with respect to long term multimedia storage may also be applied to live multimedia storage and trick modes (e.g., conversion from one compression ratio/type to another, compressing/decompressing in real time using a general purpose CPU, . . . etc).

It should be noted, that while the foregoing embodiments were described with respect to specific compression algorithms such as Real Video 8 and MPEG, other CPU-based and non-CPU-based compression algorithms (e.g., MPEG-4, AC-3, . . . etc) may be employed while still complying with the underlying principles of the invention. Moreover, although certain analog and digital embodiments were described separately (e.g., in FIG. 2 and FIG. 5, respectively), it will be readily apparent to one of ordinary skill in the art that these embodiments may be combined in a single system (i.e., capable of receiving and processing both analog and digital signals using the techniques set forth above).

Moreover, it will be appreciated that several multimedia streams may be processed concurrently by the system (depending, in part, on the speed at which the mass storage device can read/write data). For example, two live streams may be transmitted concurrently through two separate “trick mode” buffers. At the same time, two recorded streams may be temporarily stored in interim buffers and processed in the background by the CPU (e.g., from a first compression ratio/type to a second compression ratio type). In addition, the streams may be transmitted from the multimedia storage system to the rendering devices (e.g., televisions) over a variety of different data transmission channels/media, including both terrestrial cable (e.g., Ethernet) and wireless (e.g., 802.11b).

### Embodiments of an Apparatus and Method for Compressing Video

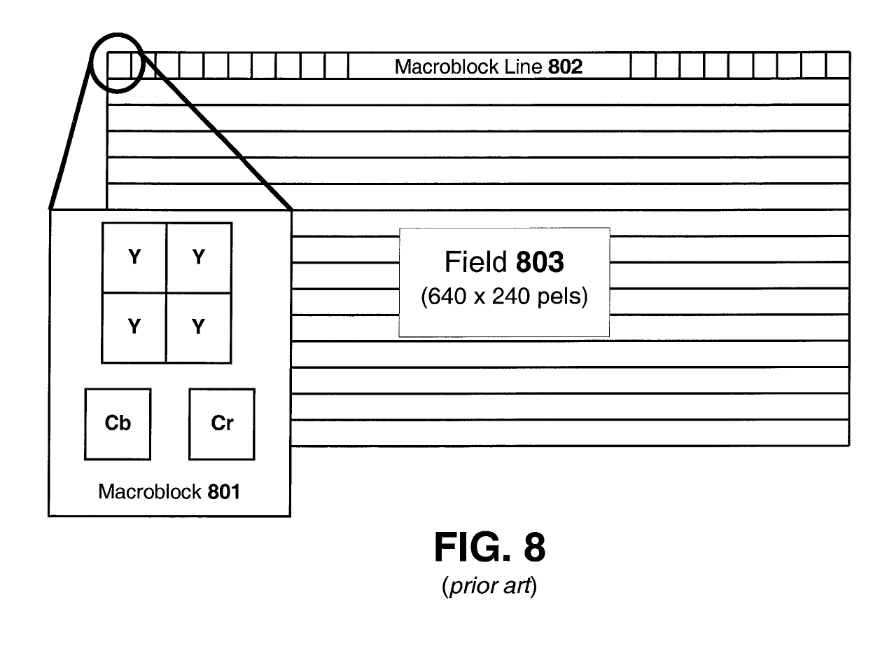

One embodiment of the invention employs a codec for compressing video using less memory and processing power than current systems while maintaining a comparable level of video quality. This embodiment will now be described with respect to FIGS. 8-15.

As mentioned above, the MPEG-2 digital compression standard exploits both spatial redundancies and temporal redundancies within a series of video images (also referred to as video “frames”). Temporal redundancies are exploited by using motion compensated prediction, forward prediction, backward prediction, and bi-directional prediction. Spatial redundancies are exploited by using field-based Discrete Cosine Transform (“DCT”) coding of 8×8 pixel blocks followed by quantization, zigzag scan, and variable length coding of runs of zero-quantized indices and amplitudes of those indices. Quantization scaling factors and quantization matrices are used to effectively remove DCT coefficients containing perceptually irrelevant information, thereby increasing the MPEG-2 coding efficiency. These functions are described in greater detail below.

In MPEG-2 terminology, each video “frame” is comprised of two video “fields.” Thus, as illustrated in FIG. 8, if the video is encoded at a resolution of 640×480 pixels (or “pels”), a field 803 within the frame will have a resolution of 640×240 pixels (i.e., with the pixels from field 1 representing even lines of the frame and the pixels from field 2 representing the odd lines of the frame in an interlaced format). A field 803 is logically divided into 600 16×16 pixel “macroblocks” 801 which are typically the smallest units of information that may be separately quantized following the DCT. The 600 macroblocks form 15 “macroblock lines” 802.

As illustrated, each macroblock 801 contains four 8×8 luminance (grayscale) (Y) components and two 8×8 chromatic (color) components (one for Cb and one for Cr). A relatively greater number of luminance components are included within each macroblock because the human eye is more sensitive to changes/inaccuracies in luminance than in chrominance.

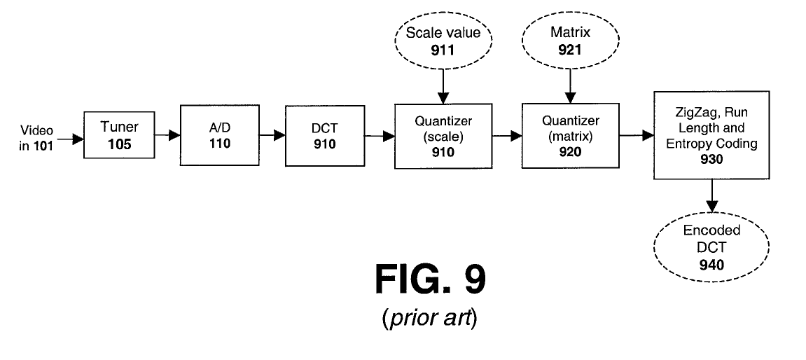

Various steps required for the DCT-encoding of each macroblock will now be described with respect FIG. 9. As mentioned above, a modulated analog video signal 101 is first converted to a baseband analog signal via a tuner module 105. The baseband analog video signal is then digitized by an analog-to-digital (“A/D”) converter to produce a raw digital video signal (e.g., in a standard digital format such as CCIR-601 or CCIR-656 established by the International Radio Consultative Committee).

The digitized signal is passed through a DCT module 910 which reduces data redundancy by generating a series of frequency coefficients for each 8×8 matrix of the macroblock. This typically includes one DC coefficient and 63 AC coefficients logically arranged in an 8×8 coefficient matrix. Two separate quantization steps are then performed to filter out insignificant DCT coefficients. First a quantizer scale module 910 divides each of the 64 coefficients by the same quantization scaling value 911 to produce an 8×8 matrix of scaled coefficients. A second quantization module 920 then divides each scaled coefficient in the 8×8 scaled coefficient matrix by a corresponding entry in an 8×8 quantization matrix 921. Each value in the resulting 8×8 matrix is then rounded to the nearest integer. Since most images tend to be characterized by lower spatial frequencies, many of the higher-frequency coefficients will be rounded to zero, effectively removing a significant amount of perceptually irrelevant information from the digital video stream (perceptually irrelevant, that is, as long as the scaling/quantization values are not set too high).

A zig-zag scan is then performed on the scaled 8×8 matrix to produce a 64-element vector (with the coefficients arranged in order of increasing spatial frequency), which is subsequently run-length encoded and entropy encoded (e.g., Huffman encoded). These functions, which are well known in the art, are represented by Zig-Zag, Run Length and Entropy Coding module 930 in FIG. 9 which outputs the final encoded DCT signal 940.

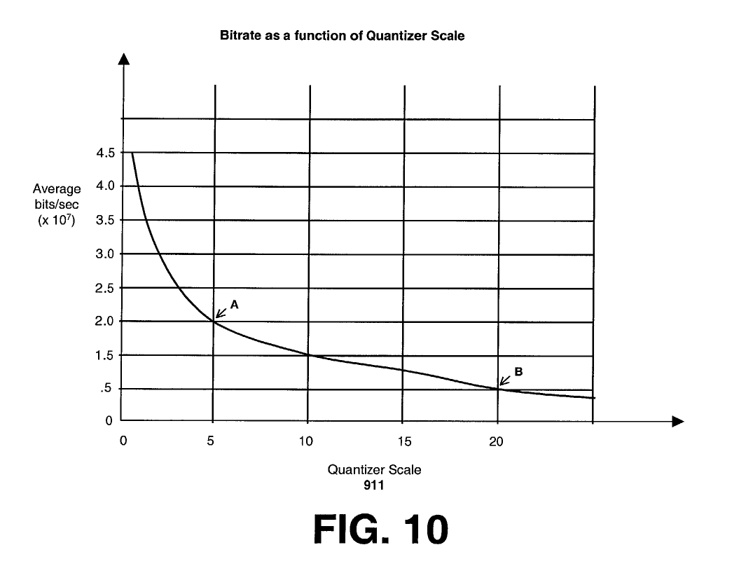

The higher the quantization scaling value 911 and/or the quantization matrix values 921, the more DCT coefficients will be rounded to zero, and the lower the effective bitrate of the video stream. For example, as illustrated in FIG. 10, as the quantization scale of a particular video stream is increased from 5 (point A) to 20 (point B) the average bits/sec required by the video stream decreases from 20 Mbits/sec to 5 Mbits/sec, respectively.

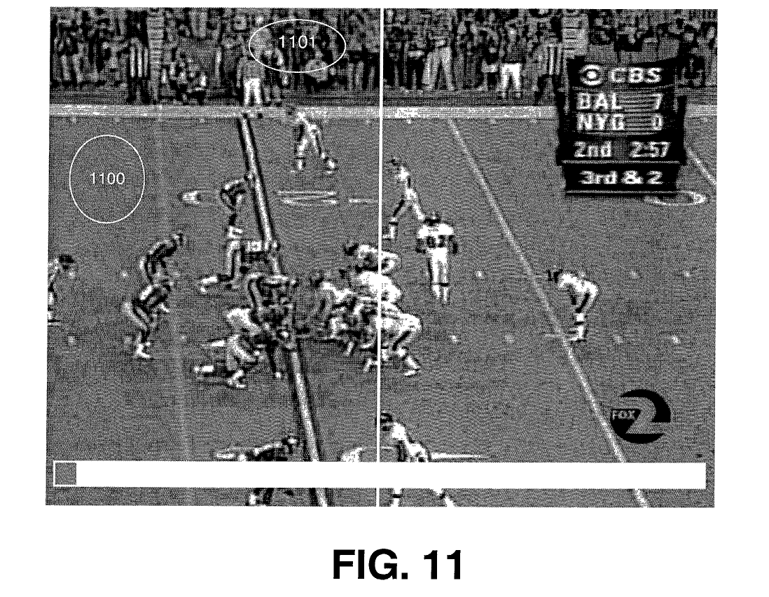

However, a large quantization scale may result in a perceptible loss of video image quality. For example, obvious, objectionable artifacts may appear within the image due to the use of an excessively coarse quantizer scale. The decrease in video quality will not be as noticeable (or may not be perceptible at all), however, in areas of the image that are relatively complex or “busy.” For example, referring to FIG. 11, the grassy area 1100 of the football field (an area with relatively low spatial activity) will be distorted more significantly using a high (coarse) quantization scale than will the area containing the people on the sidelines 1101 (i.e., an area with relatively high special activity). This is because quantization distortion artifacts resulting from relatively coarse quantization of the high frequency components within the more complex area 1101 of the image are relatively imperceptible to the human visual system. As a result, the image complexity will effectively mask any distortion resulting from the high quantization values.

With the foregoing analysis in mind, one embodiment of the invention applies a relatively higher (coarse) quantization scale to areas of the video image which are identified as relatively complex and a relatively lower (fine) quantization scale to areas identified as relatively simple. For example, referring again to FIG. 11, this embodiment might apply a quantization scale of 5 to the grassy area 1100, and a quantization scale of 20 to the area containing the people on the sidelines 1101, thereby decreasing the effective bitrate of the compressed video while at the same time maintaining an adequate level of image quality.

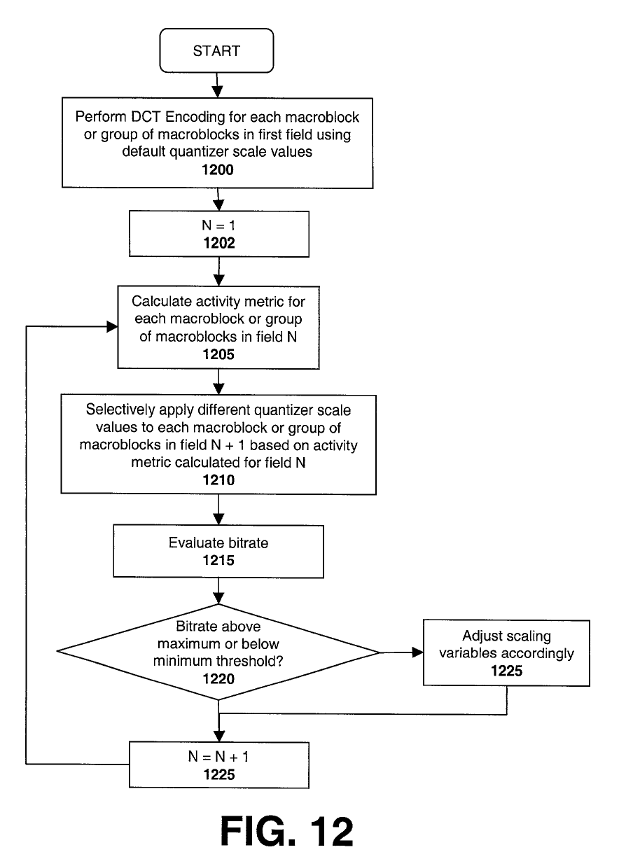

One embodiment of a computer-implemented method for adaptively adjusting the quantization scales for macroblocks (or groups of macroblocks) encoded in successive fields based on an activity metric calculated for macroblocks (or groups of macroblocks) encoded in prior fields is illustrated in FIG. 12. At 1200 each macroblock (or group of macroblocks) is DCT-encoded using a default quantization scale value. The default value may be selected based on the maximum allowable bitrate of the system and/or some minimum acceptable level of encoding quality. At 1202 the method variable N is set equal to 1.

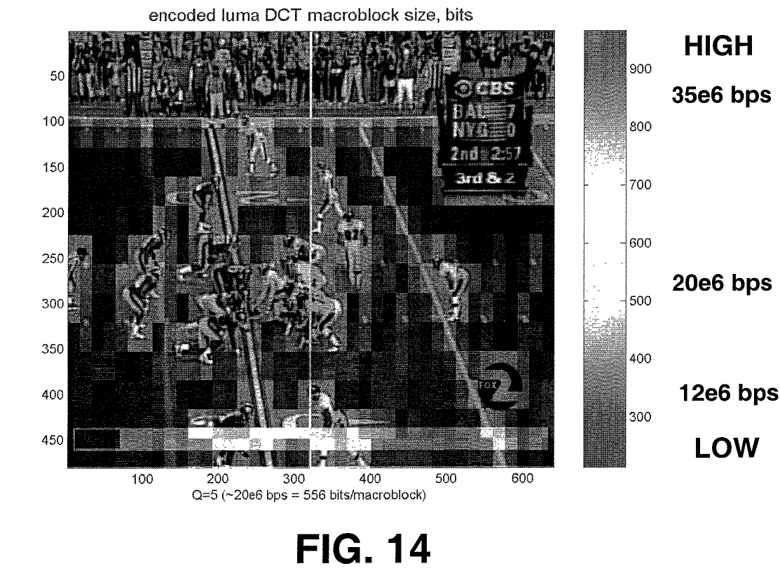

At 1205, the activity metric for each macroblock (or group of macroblocks) in the first field (i.e., N=1) is calculated. Generally, the “activity metric” is a measurement of the level of complexity (e.g., spatial activity) within a particular macroblock or group of macroblocks. In one embodiment, the activity metric is calculated based on the number of bits used to encode the macroblock or group of macroblocks (e.g., using the default quantizer scale value). In general, the greater the number of bits required to encode the macroblock, the more spatial activity within the macroblock. This relationship is graphically illustrated in FIG. 14 which plots bits/sec for the groups of macroblocks of the video image shown in FIG. 11. Note that, as described above, the area containing the people on the sidelines 1101 is encoded at a relatively higher bitrate than the grassy area 1100.

Whether a separate activity metric is calculated for each individual macroblock within the field or, alternatively, for a group of contiguous macroblocks depends on the level of precision sought in the encoding process. In some cases, calculating an activity metric for several (e.g., four) contiguous macroblocks may be sufficient. The underlying principles of the invention remain the same regardless of the number of macroblocks grouped together for the activity metric calculations.

At 1210, the macroblock activity metric calculations for the first field have been completed. As such, the activity metric data is used to selectively apply a different quantizer scale value to each macroblock or group of macroblocks in the second field (i.e., where N=1). In one embodiment, a quantizer scaling value from, for example, 4 to 20 may be associated with a particular activity metric range. For example, macroblocks with activity metric calculations between 0 and 100 bits/macroblock (e.g., area 1100) may be assigned a quantizer scaling value of 4 whereas macroblocks with activity metric calculations between 900 and 1000 bits/macroblock (e.g., area 1101) may be assigned a quantizer scaling value of 20. Various other scaling variable assignments may be associated with various activity metric ranges while still complying with the underlying principles of the invention.

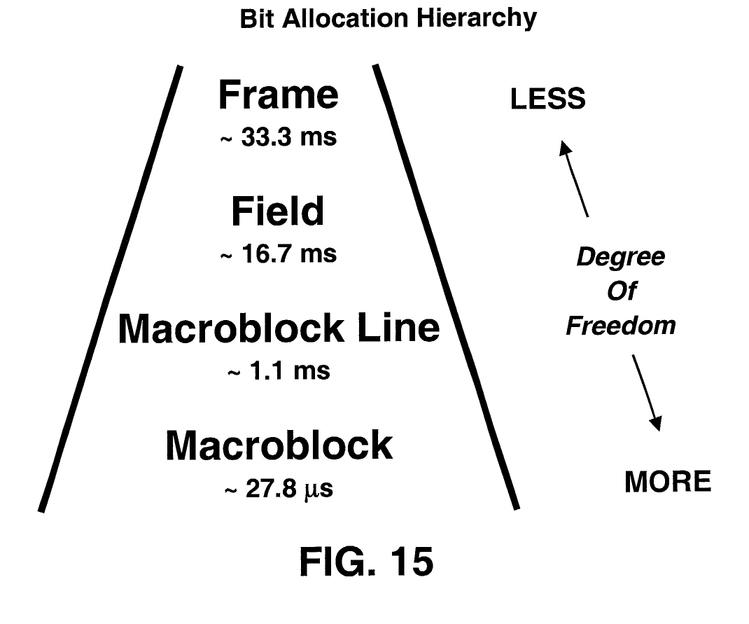

At 1215 the method variable N is reset to 1. The overall bitrate for the processed frame, in keeping with the longer-term desired bitrate, is evaluated to determine whether it is within an acceptable range (determined at 1220). If the overall bitrate is not within an acceptable range, then at 1225 the scaling variables may be raised or lowered if the bitrate is too high or low, respectively. FIG. 15 illustrates a bitrate allocation hierarchy showing the degrees of freedom for adaptive bitrate changes at different encoding levels. Note that the bitrate may be modified significantly from one macroblock to the next whereas the bitrate must be maintained at a relatively consistent level for each frame. The overall system bitrate may be based on factors such as the available system memory and processing power.

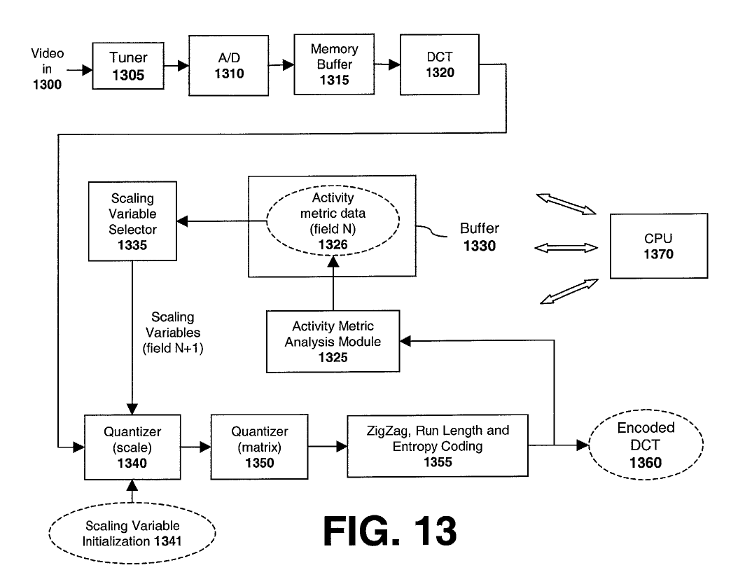

FIG. 13 illustrates one embodiment of an apparatus for adaptively encoding successive fields based on an activity metric calculated while encoding prior fields. The incoming video signal 1300 is initially converted to a baseband signal and digitized by a tuner 1305 and an analog-to-digital (“A/D”) converter 1310, respectively. A memory buffer 1315 stores a predetermined amount of digital video data before transferring the digital video data to a DCT module 1320 which performs a DCT on the signal as described above. In one embodiment the buffer memory 1315 stores one macroblock line of data; however, various other buffer sizes may be employed.

A quantizer scaling module 1340 initially applies a default quantizer scaling value 1341 to the signal (e.g., to the first field being processed). As described above, the default value 1341 may be selected based on variables such as the maximum allowable bitrate of the system and/or some minimum acceptable level of encoding quality.

A quantizer matrix module 1350 divides each of the coefficients by corresponding values in a quantizer matrix and a zig-zag scan, run-length and entropy encoding module 1355 completes the DCT encoding process for the macroblocks in the first field, processing the signal as described above (see, e.g., FIG. 9 and associated text). Unlike prior systems, however, an activity metric analysis module 1325 calculates an activity metric for each macroblock or group of macroblocks within the first field (e.g., based on the number of bits allocated for each DCT-encoded macroblock or macroblock group). Although the activity metric module 1325 is illustrated in FIG. 13 calculating activity metric data 1326 based on the DCT-encoded signal 1360, it should be noted that the activity metric calculations described herein may be performed at any video processing stage (e.g., directly after the signal is encoded via DCT module 1320, following the DCT scaling via module 1340, . . . etc).

A buffer memory 1330 temporarily stores the activity metric data 1326 during the encode of the first field (or ‘field N’ field if the first field has already been processed). In one embodiment, the buffer memory is a 600-byte random access memory (“RAM”) having one byte allocated to store the activity metric for each macroblock (recall that each field is comprised of 600 macroblocks). However, various other buffer sizes and buffer types may be employed to store the activity metric data consistent with the underlying principles of the invention.

Once the first field (or field N) has been encoded, a scaling variable selector module 1335 applies different scaling variables to each macroblock (or macroblock group) in the second field (or field N+1) based on the activity metric data 1326 calculated for corresponding macroblocks (or macroblock groups) in the first field (or field N). As described above, various different scaling variable mappings may be applied to activity metric ranges while still complying with the underlying principles of the invention (e.g., scaling variable 7 may correspond to the activity metric range of 200-290 bits/macroblock; scaling variable 10 may correspond to the activity metric range of 400-480, . . . etc).

As described above, generating temporal redundancies between frames (e.g., motion compensated prediction, forward prediction, etc) during MPEG encoding requires a significant amount of memory because several frames must be concurrently stored in memory so that the temporal redundancies may be analyzed and exploited. Moreover, if the MPEG encoding is to occur in real time, a significant amount of processing power may be required. As such, one embodiment of the invention solely employs the field-based encoding techniques described herein to minimize the memory and processing requirements for real time video compression. However, it should be noted that these field-based encoding techniques may be coupled with various other MPEG-based encoding techniques (e.g., temporal processing techniques such as motion compensation prediction) and/or non-MPEG-based encoding techniques (e.g., wavelet compression techniques) while still complying with the underlying principles of the invention.

In one embodiment of the invention, the activity metric data may be used to select a different quantizer matrix and/or to modify the quantizer values within the existing quantizer matrix. Accordingly, in this embodiment a matrix selection/modification module (not shown) may be employed to interpret the activity metric data and select an appropriate matrix or set of matrices for each macroblock (or macroblock group) based on the complexity of the video image within the macroblock. In one embodiment, a set of prefabricated quantizer matrices may be stored in memory (e.g., a ROM) and accessed based on the activity metric data. This may be done either in lieu of or in addition to changing the quantizer scaling value as described above.

The field-based video compression techniques described with respect to FIGS. 8 through 15 may be employed in any of the systems described with respect to FIGS. 2 through 7c. For example, a compression module employing the field-based compression techniques may be substituted for the light compression module 410 illustrated in FIG. 4. Similarly, with respect to FIGS. 2 and 3, the digitized video content may initially be stored to a mass storage device 120 in an uncompressed format. A central processing unit may then employ the compression techniques as a background process to compress the video content (as described in detail above). Various other combinations of the systems and methods described herein are contemplated as additional embodiments of the invention.

Embodiments of the invention include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the present system and method. It will be apparent, however, to one skilled in the art that the system and method may be practiced without some of these specific details. In other instances, well known structures and functions were not described in detail in order to avoid obscuring the subject matter of the present invention. Accordingly, the scope and spirit of the invention should be judged in terms of the claims which follow.

What is claimed is:

1. A computer-implemented method for compressing video comprising:
calculating an activity metric for macroblocks in a first field; and
selecting a quantizer scaling value for corresponding macroblocks in a second field based on said calculated activity metric.

2. The method as in claim 1 wherein calculating an activity metric comprises:
determining a number of bits allocated to each of said macroblocks.

3. The method as in claim 2 wherein said number of bits are determined after said macroblocks in said first field have been run-length and entropy encoded.

4. The method as in claim 2 wherein said number of bits are determined directly following a discrete cosine transform (“DCT”) of said macroblocks in said first field.

5. The method as in claim 1 wherein selecting comprises:
selecting relatively higher quantizer scaling values for corresponding macroblocks if said calculated activity metric is relatively high and relatively lower quantizer scaling values for corresponding macroblocks if said calculated activity metric is relatively low.

6. The method as in claim 1 further comprising:
determining whether calculating said activity metric and selecting said quantizer scaling values for said first and second fields, respectively, produces a bitrate above a predetermined maximum threshold; and
adjusting said quantizer scaling values to lower said bitrate if said bitrate is above said predetermined maximum threshold.

7. The method as in claim 1 wherein said first and second fields are in different frames.

8. The method as in claim 1 further comprising:
selecting a particular quantizer matrix for corresponding macroblocks in said second field based on said calculated activity metric.

9. An apparatus for compressing video comprising:
an activity metric analysis module to calculate an activity metric for macroblocks in a first field; and
a scaling variable selector module to select a quantizer scaling value for corresponding macroblocks in a second field based on said calculated activity metric.

10. The apparatus as in claim 9 wherein calculating an activity metric comprises:
determining a number of bits allocated to each of said macroblocks.

11. The apparatus as in claim 10 wherein said number of bits are determined after said macroblocks in said first field have been run-length and entropy encoded.

12. The apparatus as in claim 10 wherein said number of bits are determined directly following a discrete cosine transform (“DCT”) of said macroblocks in said first field.

13. The apparatus as in claim 9 wherein selecting comprises:
selecting relatively higher quantizer scaling values for corresponding macroblocks if said calculated activity metric is relatively high and relatively lower quantizer scaling values for corresponding macroblocks if said calculated activity metric is relatively low.

14. The apparatus as in claim 9 further comprising:
determining whether calculating said activity metric and selecting said quantizer scaling values for said first and second fields, respectively, produces a bitrate above a predetermined maximum threshold; and
adjusting said quantizer scaling values to lower said bitrate if said bitrate is above said predetermined maximum threshold.

15. The apparatus as in claim 9 wherein said first and second fields are in different frames.

16. The apparatus as in claim 9 further comprising:
a quantizer matrix selector module to select a particular quantizer matrix for corresponding macroblocks in said second field based on said calculated activity metric.

17. A method comprising:
encoding a first video image in a series of images with a first quantizer scaling value;
calculating spatial activity within a first area in said first video image; and
selecting a second quantizer scaling value in a corresponding first area in a second video image based on said spatial activity within calculated for said first area.

18. The method as in claim 17 wherein selecting further comprises:
selecting a relatively higher second quantizer scaling value if said calculated spatial activity is above a first threshold value and a relatively lower second quantizer scaling value if said spatial activity is below a second threshold value.

19. The method as in claim 17 wherein said first and second video images are first and second video fields comprising a video frame.

20. The method as in claim 19 wherein said first area is a macroblock within said first and second video fields.

21. The method as in claim 17 further comprising:
calculating spatial activity within a second area in said first video image; and
selecting a third quantizer scaling value in a corresponding second area in a second video image based on said spatial activity within calculated for said second area.

22. The method as in claim 21 further comprising:
selecting a relatively higher third quantizer scaling value if said calculated spatial activity in said second area is above a first threshold value and a relatively lower third quantizer scaling value if said spatial activity in said second area is below a second threshold value.

23. An article of manufacture including program code which, when executed by a machine, cause said machine to perform the operations of:
calculating an activity metric for macroblocks in a first field; and
selecting a quantizer scaling value for corresponding macroblocks in a second field based on said calculated activity metric.

24. The article of manufacture as in claim 23 wherein calculating an activity metric comprises:
determining a number of bits allocated to each of said macroblocks.

25. The article of manufacture as in claim 24 wherein said number of bits are determined after said macroblocks in said first field have been run-length and entropy encoded.

26. The article of manufacture as in claim 24 wherein said number of bits are determined directly following a discrete cosine transform (“DCT”) of said macroblocks in said first field.

27. The article of manufacture as in claim 23 wherein selecting comprises:
selecting relatively higher quantizer scaling values for corresponding macroblocks if said calculated activity metric is relatively high and relatively lower quantizer scaling values for corresponding macroblocks if said calculated activity metric is relatively low.

28. The article of manufacture as in claim 23 including additional program code to cause said machine to perform the operations of:
determining whether calculating said activity metric and selecting said quantizer scaling values for said first and second fields, respectively, produces a bitrate above a predetermined maximum threshold; and
adjusting said quantizer scaling values to lower said bitrate if said bitrate is above said predetermined maximum threshold.

29. The article of manufacture as in claim 23 wherein said first and second fields are in different frames.

30. The article of manufacture as in claim 23 including additional program code to cause said machine to perform the operations of:
selecting a particular quantizer matrix for corresponding macroblocks in said second field based on said calculated activity metric.

31. An article of manufacture including program code which, when executed by a machine, cause said machine to perform the operations of:
encoding a first video image in a series of images with a first quantizer scaling value;
calculating spatial activity within a first area in said first video image; and
selecting a second quantizer scaling value in a corresponding first area in a second video image based on said spatial activity within calculated for said first area.

32. The article of manufacture as in claim 31 wherein selecting further comprises:
selecting a relatively higher second quantizer scaling value if said calculated spatial activity is above a first threshold value and a relatively lower second quantizer scaling value if said spatial activity is below a second threshold value.

33. The article of manufacture as in claim 31 wherein said first and second video images are first and second video fields comprising a video frame.

34. The article of manufacture as in claim 33 wherein said first area is a macroblock within said first and second video fields.

35. The article of manufacture as in claim 31 including additional program code to cause said machine to perform the operations of:
calculating spatial activity within a second area in said first video image; and
selecting a third quantizer scaling value in a corresponding second area in a second video image based on said spatial activity within calculated for said second area.

36. The article of manufacture as in claim 35 including additional program code to cause said machine to perform the operations of:
selecting a relatively higher third quantizer scaling value if said calculated spatial activity in said second area is above a first threshold value and a relatively lower third quantizer scaling value if said spatial activity in said second area is below a second threshold value.

37. The article of manufacture as in claim 31 wherein calculating spatial activity comprises determining a number of bits required to encode said first area in said first video image.
